(19) United States
(12) Patent Application Publication
(10) Pub. No.: US 2018/0121083 A1
(43) Pub. Date: May 3, 2018

(54) USER INTERFACE FOR INFORMATIONAL INPUT IN VIRTUAL REALITY ENVIRONMENT

(71) Applicant: Alibaba Group Holding Limited, George Town (KY)

(72) Inventors: Lei Jiao, Hangzhou (CN); Huanmi Yin, Hangzhou (CN)

(73) Assignee: Alibaba Group Holding Limited, George Town (KY)

(21) Appl. No.: 15/794,814

(22) Filed: Oct. 26, 2017

(30) Foreign Application Priority Data
Oct. 27, 2016 (CN) 201610958077.9

(51) Int. Cl. G06F 3/0488; G06F 3/01; G06T 13/20

(52) U.S. Cl. CPC G06F 3/04886; G06T 13/20; G06F 3/017; G06F 3/012

(57) ABSTRACT

Responsive to receiving an indication of an input initiation, an input starting point and multiple virtual keys are presented in a virtual reality scenario. Each of the multiple virtual keys has at least one noninterfering path from the input starting point to each virtual key. The noninterfering path is not interfered by any other virtual keys. Displacement data of a focus of attention is received from sensing hardware. Responsive to determining that the focus of attention reaches the input starting point based on the displacement data, detection of a virtual key input is activated. Responsive to detecting that the focus of attention moves from the input starting point to a first virtual key, it is determined that the first virtual key is input; and the detection of the virtual key input is terminated.

This application claims priority to Chinese Patent Application No. 201610958077.9, filed on Oct. 27, 2016, which is incorporated by reference in its entirety.

### BACKGROUND

Virtual Reality (VR) technology uses computer processing, graphics, and various types of user interfaces (for example, visual display goggles and interactive controllers held in one or more hands) to produce an immersive, user-perceived three-dimensional (3D) environment (a “virtual world”) with interactive capabilities. In a VR scenario, a variety of operable virtual keys can be provided for the user. The user can trigger corresponding inputs by selecting these operable keys to interact with the VR scenario.

### SUMMARY

The present disclosure describes informational input in a virtual reality (VR) environment.

In an implementation, responsive to receiving an indication of an input initiation, an input starting point and multiple virtual keys are presented in a virtual reality scenario. Each of the multiple virtual keys has at least one noninterfering path from the input starting point to the each virtual key. The noninterfering path is not interfered by any other virtual keys. Displacement data of a focus of attention is received from sensing hardware. Responsive to determining that the focus of attention reaches the input starting point based on the displacement data, detection of a virtual key input is activated. Responsive to detecting that the focus of attention moves from the input starting point to a first virtual key, it is determined that the first virtual key is input; and the detection of the virtual key input is terminated.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, the described informational input techniques increase ease and speed of informational input in a VR environment. Second, the described informational input techniques reduce the chance of misdetection and increase detection accuracy of the informational input in the VR environment. Third, the described informational input techniques improve user experience with VR technology. Fourth, improvements to the user experience with VR technology informational input can help expand the application of VR technology to additional usage scenarios. Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### DESCRIPTION OF DRAWINGS

FIG. 1 is a diagram illustrating a prior art virtual keyboard in a virtual reality (VR) environment.

FIG. 2 is a flow chart illustrating an example of a method for informational input in a VR environment, according to an implementation of the present disclosure.

FIG. 3 is a diagram illustrating an example virtual keyboard layout for informational input in a VR environment, according to an implementation of the present disclosure.

FIG. 4 is a diagram illustrating another example virtual keyboard layout for informational input in a VR environment, according to an implementation of the present disclosure.

FIG. 5 is a diagram illustrating another example virtual keyboard layout for informational input in a VR environment, according to an implementation of the present disclosure.

FIG. 6 is a block diagram illustrating an example path of a focus of attention, according to an implementation of the present disclosure.

FIG. 7 is a block diagram illustrating an example architecture of a hardware input apparatus in a VR scenario, according to an implementation of the present disclosure.

FIG. 8 is a block diagram illustrating an example hardware input apparatus in a VR scenario, according to an implementation of the present disclosure.

FIG. 9 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes informational input in a virtual reality (VR) environment, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

VR technology uses computer processing, graphics, and various types of user interfaces (for example, visual display goggles and interactive controllers held in one or more hands) to produce an immersive, user-perceived three-dimensional (3D) environment (a “virtual world”) with interactive capabilities. Applications of VR technology (for example, in education, video games, business, science, and medicine) are increasing with continued improvements in computing hardware and software used in VR technology. While VR technology can provide a user with a convincing lifelike visual experience of a virtual world, conventional user interaction with a scenario within the 3D environment has proven to be difficult or awkward, particularly with respect to informational input (for example, alphanumeric textual data). Increasing ease and speed of informational input is necessary to improve overall user experience with VR technology.

Described are informational input techniques that can increase ease, speed, and accuracy of informational input in a VR scenario. In some implementations, a VR terminal can provide a user interface for a user to interface with VR technology. For example, a VR terminal can include a VR headset worn on the user's head providing visual displays to display graphics and other data, providing a 3D immersive experience for the user (for example, using a VR-based application).

The graphics and other data are provided by a VR client terminal (for example, a software application) communicatively coupled to the VR terminal. The VR client terminal outputs a VR model developed by a developer as a VR scenario in a VR environment. As an example, the VR terminal can be a sliding-type VR headset in which a mobile computing device (such as, a smartphone or tablet) can be inserted to provide a visual-type display and other computing functionality (for example, user input, visual input, spatial orientation, movement detection, audio generation, network connectivity, and an attachment for other user interface devices). In this example, the mobile computing device can act in whole or in part as the VR client terminal, or as an interface for a separate VR client terminal (for example, a PC-type computer connected to the mobile computing device).

To assist with informational input, a virtual keyboard that includes multiple virtual keys can be presented to the user in the VR scenario. The terminal (for example, VR glasses) can determine a focus of attention of the user by monitoring a head motion or a visual focus of the user, so that the user can control displacement of the focus of attention through the head motion or visual movement, so as to select a virtual key.

In the related technology, a user can control movement of a cursor and click keys of a virtual keyboard on a computer by using a physical input device (for example, a mouse), and the mouse cursor is equivalent to a focus of attention of the user in a display page. A virtual key on which the user focuses can be selected by moving the focus of attention, and is clicked to complete the control. As another example, a user can tap one or more keys of a virtual keyboard on a touch phone. In a touch input mechanism, after determining a virtual key to input, the user can touch the virtual key with a finger to complete the control.

However, in a VR scenario, in some instances, because the user may need to move in a space, a stable mouse operating platform cannot be provided. Therefore, the mouse may not be applied to a VR environment. On the other hand, the user wearing VR glasses may not be able to see his/her hands, and therefore may not be able to select and tap the virtual keys of the virtual keyboard with a finger directly.

Currently, in a VR scenario, an input control may be implemented through two stages: “move” and “tap”. A main principle is as follows: when the head or visual focus is in a motion state, it can be determined that the operation is in the “move” stage. When non-motion duration reaches or exceeds a predetermined duration, it can be determined that the operation is in the “tap” stage. Such an implementation has a relatively high requirement regarding the operation proficiency of the user. The distinction between the two stages is not readily apparent, and thus can easily result in misjudgment or misdetection on “move” and “tap”.

Described are informational input techniques that allow the user to control the focus of attention to move from an input starting point to a region where a to-be-input virtual key is located, so as to input the virtual key. In this way, the intended input of the user can be correctly determined without requiring the user to put the focus of attention on a virtual key for a long time. In some implementations, the operation is easy, the input speed is fast, and recognition accuracy is high, thus improving user experience in the VR scenario.

In some implementations, the described informational input techniques include three stages: creation of a VR scenario model, displacement tracking of a focus of attention, and input of a virtual key.

1. Creation of a VR Scenario Model

In some implementations, a VR developer can complete creation of a VR scenario model by using a modeling tool (for example, UNITY, 3DSMAX, or PHOTOSHOP). The modeling tool can be, for example, proprietary, commercial, open source, or a combination of these types of modeling tools.

In some instances, the VR scenario model and texture map(s) associated with the VR scenario can be obtained from real-world scenarios. For example, a texture map of a material and a planar model of a real scenario may be obtained through advanced photography. Using the modeling tool, texture can be processed and a 3D model of the real scenario established. In some implementations, the processed texture and the 3D model can be imported to a UNITY3D platform and image rendering can be carried out in multiple aspects (such as, a sound effect, a graphical user interface (GUI) or other user interface (UI), a plug-in, and lighting in the UNITY3D platform). Interaction software code can be written for the VR scenario model.

In some implementations, the developer can further create, in addition to the VR scenario model, an input starting point and multiple virtual keys by using the modeling tool, so that the user can better interact with the VR scenario. The virtual keys can include, for example, numeric keys for inputting numbers, alphabetic keys for inputting letters, punctuation keys for inputting symbols, etc. Shapes or forms of the virtual keys are not limited, and can be customized based on user preference. In some implementations, there can be an appropriate gap between the virtual keys to avoid misdetection of the input virtual keys. For example, there can be an appropriate gap between each two closest virtual keys of the multiple virtual keys presented to the user.

In some implementations, after the developer completes the VR scenario model and modeling of the virtual keys and the input starting point, the VR client terminal can output, to the user, the VR scenario model by using a VR terminal (for example, a VR headset) connected to the VR client terminal. Upon reception of an indication of the input initiation from the user, the input starting point and the virtual keys can be presented in the VR scenario.

2. Displacement Tracking of a Focus of Attention

In some implementations, by default, a focus of attention (also referred to as a visual or an operational focus) can be displayed in a user view in the VR scenario output by the VR client terminal. When the user needs to input information during an immersive experience associated with the VR scenario (for example, by wearing a VR terminal), the user can control displacement of the focus of attention in the VR scenario through, for example, a head posture or a hand gesture, to interact with the VR scenario.

The VR client terminal can track displacement of the head or hand of the user by using sensing hardware carried by the VR terminal, and the sensing hardware can detect and collect displacement data of the head or hand, for example, in real time, when the user wears the VR terminal. The sensing hardware can include, for example, an angular velocity sensor, an acceleration sensor, a gravity sensor, etc.

Upon receiving the displacement data of the head or hand of the user, the sensing hardware can return the collected displacement data to the VR client terminal, for example, in real time. Upon receiving the displacement data returned by the sensing hardware, the VR client terminal can control, according to the displacement data, the focus of attention output in the VR scenario to have synchronous displacement.

For example, in some implementations, the VR terminal can calculate, based on the received displacement data, offsets of the head or hand of the user with respect to an X axis and a Y axis in the VR scenario, and then control displacement of the focus of attention in real time on the basis of the calculated offsets.

In some implementations, the displacement of the head or hand of the user can be tracked by using the sensing hardware carried by the VR terminal, and the focus of attention can be controlled using the VR client terminal to have synchronous displacement with the head or hand of the user. In some implementations, the VR client terminal can, in the process of controlling the focus of attention to have synchronous displacement, further track displacement of the focus of attention in real time, record a coordinate position of the focus of attention in the VR scenario in real time, and then generate a displacement track record or path of the focus of attention in the VR scenario, according to the coordinate position of the focus of attention recorded in real time.

3. Input of a Virtual Key

In some implementations, the user can control a path of the focus of attention to move from an input starting point in the VR scenario, through a noninterfering path, to a region where a virtual key, corresponding to the noninterfering path, is located, to trigger input of the virtual key.

In some implementations, after presenting the input starting point and the multiple virtual keys, the VR client terminal can track the displacement of the focus of attention in real time, activate a virtual key input detection in response to determining that the focus of attention reaches the input starting point and, when detecting that the focus of attention moves from the input starting point to a region where a first virtual key is located, determine that the virtual key is selected by the user, and then terminate the current virtual key input detection.

In some implementations, if the virtual key input detection is not activated, even if the user controls the focus of attention to move to a virtual key, input of this virtual key cannot be triggered. In other words, in this case, displacement of the focus of attention is tracked in real time, and the virtual key input detection has a trigger mechanism rather than being performed in real time. For example, supposing that the user controls the focus of attention to move from the input starting point to a virtual key 0, it is determined that 0 is input. If the user continues to control the focus of attention to move from 0 to 1, because the virtual key input detection is terminated after 0 is selected, the input of 1 is not triggered. The virtual key input detection is activated only when the user controls the focus of attention to move back to the input starting point. If the focus of attention continues to move from the input starting point to the virtual key of 1 again, it can be determined that 1 is input by the user.

In some implementations, the user can control the focus of attention to move from the input starting point to a virtual key through a straight line, a curve, or other path to input the virtual key. That is, a noninterfering path can be a straight line, a curve, or another shape.

In some implementations, an animation or auxiliary line can be presented in the VR scenario, for example, in response to the determination that an indication of the input initiation is received, so as to prompt or guide the user on how to input a virtual key. In some implementations, because a line segment is the shortest between two points, the animation or auxiliary line may prompt the user to control the focus of attention to move from the input starting point to a virtual key along a straight line. In some implementations, in a VR scenario, a distance from an input starting point to each of the multiple virtual keys is generally not too far. The user can control, by a slight body movement, the focus of attention to move, along a straight line or a substantially straight line, from the input starting point to a region where a virtual key is located, to input the virtual key. The animation and auxiliary line may also be created with reference to the foregoing creation of a VR scenario model, and details are not enumerated in the present disclosure.

In some implementations, when the focus of attention reaches the input starting point, a presentation effect (for example, color, shape, or size) of the focus of attention can be changed, so as to enable the user to know whether the focus of attention already reaches the input starting point. For example, the focus of attention is black by default, and when it reaches the input starting point, its color may be adjusted to green, so as to prompt the user to input a virtual key. Moreover, after the virtual key is successfully input, the color of the focus of attention can adjusted back to black. Additional or different presentation effects, such as the shape of the focus of attention, can be changed.

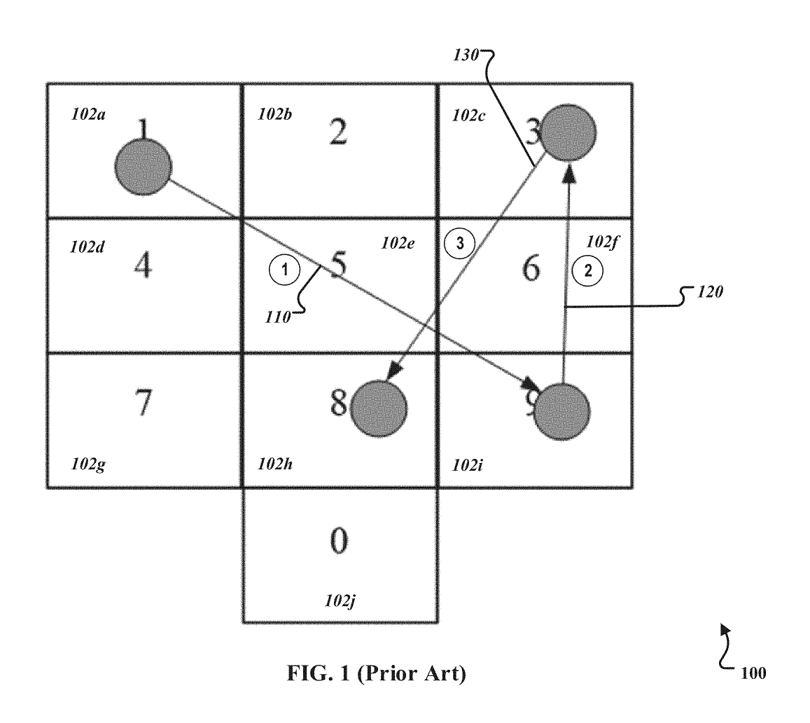

FIG. 1 is a diagram illustrating a prior art virtual keyboard 100 in a VR environment. The virtual keyboard 100 includes 10 numeric virtual keys “1” 102a, “2” 102b, “3” 102c, “4” 102d, “5” 102e, “6” 102f, “7” 102g, “8” 102h, “9” 102i, and “0” 102j. As an example, if a user wants to input “1938,” a moving path of the focus of attention is as follows: path \textcircled{1} 110→path \textcircled{2} 120→path \textcircled{3} 130. However, in the virtual keyboard 100, the path \textcircled{1} 120 passes through or across virtual keys “1” 102a, “5” 102e, and “9” 102i. If the user's movement slows down or becomes unsmooth, for example, if the user stops for a short period of time when passing through the virtual key “5” 102e, it may be recognized by a VR device that the user “confirms” input of 5, resulting in misjudgment. Similarly, the path \textcircled{2} 120 passes across the virtual key “6” 102f, and the path \textcircled{3} 130 passes across the virtual keys “5” 102e, and “6” 102f. The paths 110, 120, 130 either interfere with each other or pass across other virtual keys. Such a layout of the virtual keyboard 100 may lead to misdetection of the informational input.

The present disclosure provides an input solution in a VR scenario to avoid or reduce the likelihood of misdetection. In some implementations, in addition to virtual keys of a virtual keyboard, an input starting point can be presented in the VR scenario. There is a certain desirable location relationship between the input starting point and the virtual keys. A user can be guided to control a focus of attention to depart from the input starting point. When it is detected that the focus of attention moves from the input starting point to a first virtual key, it can be determined that the virtual key is input by the user. In some implementations, the disclosed input techniques allow easy user operation, prevent or avoid midsection, and provide accuracy input recognition or detection, thus improving user experience in the VR scenario.

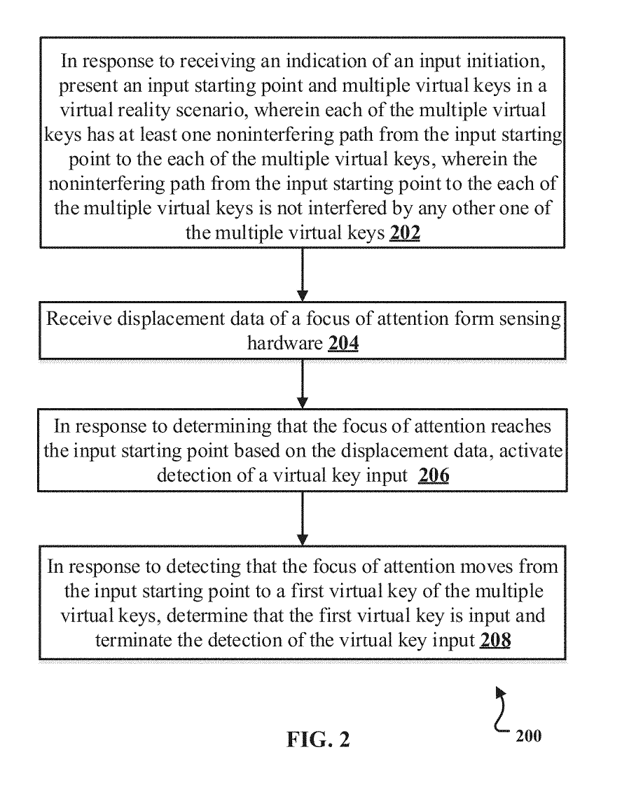

FIG. 2 is a flowchart illustrating an example of a method 200 for informational input in a VR environment, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

In some implementations, the method 200 can be an input method of a VR client terminal in a VR scenario. In some implementations, a VR client terminal can refer to client terminal software developed on the basis of a VR technology and providing a three-dimensional immersive user experience, for example, a VR-based APP. The VR client terminal can output, to the user, by using a VR terminal (for example, a VR headset or a VR goggle) connected to the VR client terminal, a VR scenario model developed by a developer, so that the user wearing the VR terminal can have a three-dimensional immersive experience in the VR scenario.

At 202, in response to receiving an indication of an input initiation, an input starting point and multiple virtual keys are presented in a VR scenario. The indication of the input initiation indicates that an input to the VR terminal is about to be started, enabled, activated, or otherwise initiated. In some implementations, the input initiation is triggered by a user of the VR terminal. For example, the user may trigger the input initiation by touching a predetermined physical key, performing a body movement, using voice control, or engaging in any other activities to instruct the VR terminal that an input is about to be initiated.

Upon reception of the indication of the input initiation, the input starting point and a number of virtual keys can be presented, for example, as a virtual keyboard, in the current VR scenario. The virtual keyboard may include additional or different buttons, icons, or control modules.

The input starting point and the multiple virtual keys can be presented such that they have a certain layout or location relationship, to reduce the likelihood of misdetection. In some implementations, each of the multiple virtual keys has at least one noninterfering path from the input starting point to the each of the multiple virtual keys, wherein the noninterfering path from the input starting point to the each of the multiple virtual keys is not interfered by any other one of the multiple virtual keys. As an example, the noninterfering path from the input starting point to the each of the multiple virtual keys does not pass through or across any other virtual keys of the multiple virtual keys. In other words, there is no intervening virtual key that exists on the noninterfering path connecting the input starting point and the destined virtual key.

In some implementations, each of the multiple virtual keys has at least one noninterfering path from the input starting point to each of the multiple virtual keys, wherein the noninterfering path from the input starting point to each of the multiple virtual keys does not interfere with another noninterfering path from the input starting point to another one of the multiple virtual keys.

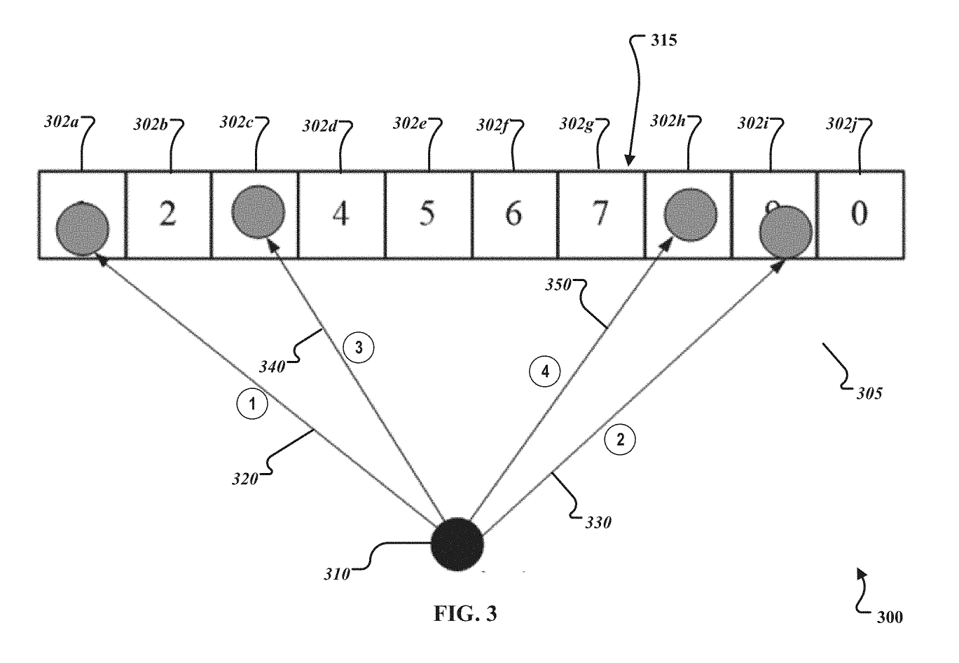

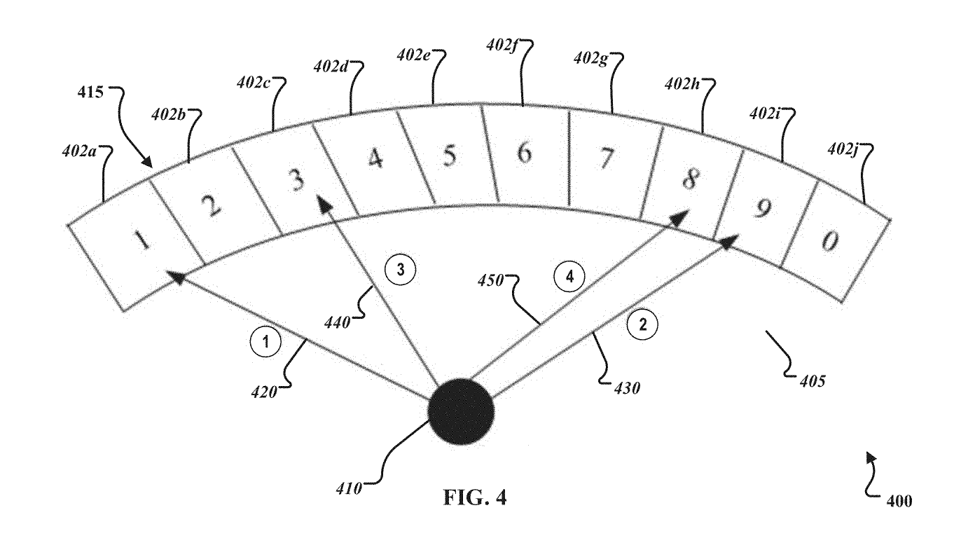

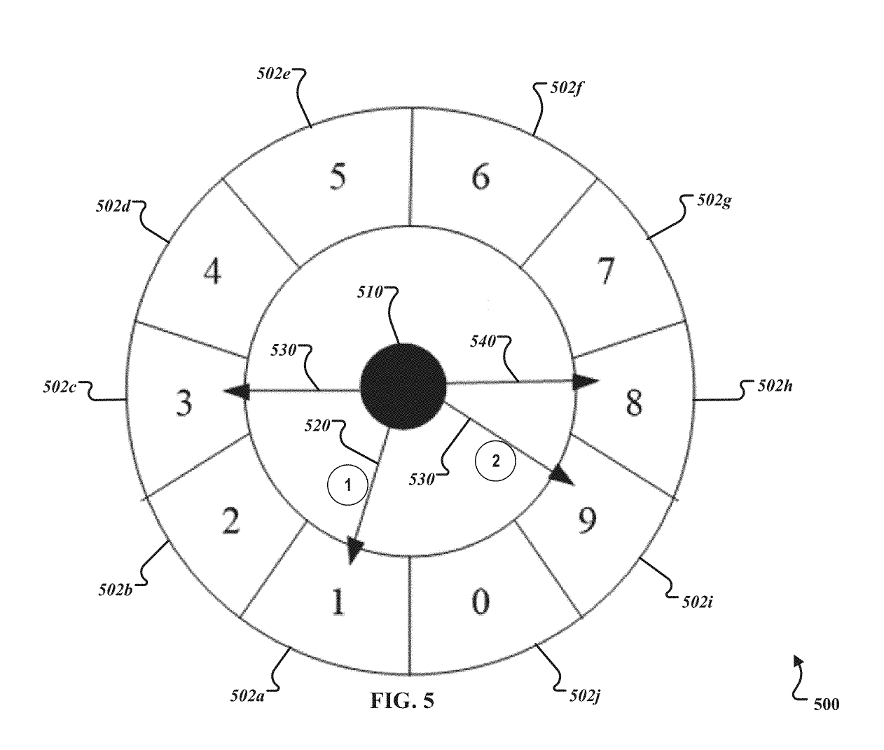

The shape, size, or other presenting attributes of the input starting point and the virtual key can be set, for example, by a developer or a user. As an example, the input starting point can be a straight line, a dot, or a circular region; the virtual keys can be a circle, a square, or a diamond. In some implementations, in the case that where the input starting point is a circular or another shape of a region or an area, any point in the region needs to satisfy the location relationship with the virtual keys to reduce or avoid misdetection. FIGS. 3-5 show example virtual keyboard layouts with satisfying location relationships between the input starting point and the virtual keys. In some implementations, the multiple virtual keys are aligned along a straight line, and the input starting point is located at either side of an elongated area formed by the multiple virtual keys, for example, as shown in FIG. 3. In some implementations, the multiple virtual keys are arranged along a curve such as an arc, and the input starting point is located on an inner side of the arc, for example, as shown in FIG. 4. In some implementations, the multiple virtual keys are arranged along a circle, and the input starting point is located inside the circle, for example, as shown in FIG. 5.

FIG. 3 is a diagram illustrating an example virtual keyboard layout 300 for informational input in a VR environment, according to an implementation of the present disclosure. The virtual keyboard layout 300 shows a first example location relationship between an input starting point 310 and virtual keys “1” 302a, “2” 302b, “3” 302c, “4” 302d, “5” 302e, “6” 302f, “7” 302g, “8” 302h, “9” 302i, and “0” 302j. The virtual keys 302a-j are lined up along a straight line. The input starting point 310 can be located at either side 305 or 315 of a location area formed by the virtual keys 302a-j, to ensure that each of the virtual keys 302a-j has one or more noninterfering paths that are not interfered by other virtual keys. For example, as shown in FIG. 3, a path \textcircled{1} 320 is a noninterfering path from the input starting point 310 to a virtual key “1” 302a; a path \textcircled{2} 330 is a noninterfering path from the input starting point 310 to a virtual key “9” 302i; a path \textcircled{3} 340 is a noninterfering path from the input starting point 310 to a virtual key “3” 302c; a path \textcircled{4} 350 is a noninterfering path from the input starting point 310 to a virtual key “8” 302h. When the user wants to input 1, the user may control the focus of attention to move from the input starting point 310 to the virtual key “1” 302a along the path \textcircled{1} 320.

FIG. 4 is a diagram illustrating another example virtual keyboard layout 400 for informational input in a VR environment, according to an implementation of the present disclosure. The virtual keyboard layout 400 shows a first example location relationship between an input starting point 410 and virtual keys “1” 402a, “2” 402b, “3” 402c, “4” 402d, “5” 402e, “6” 402f, “7” 402g, “8” 402h, “9” 402i, and “0” 402j. The virtual keys 402a-j are arranged along an arc (for example, a segment of a circle or ellipse). The input starting point 410 can be located on an inner side 405 of an arc area formed by the virtual keys 402a-j. The inner side 405 can be the side where the center of the corresponding circle or ellipse resides. In some implementations, the input starting point 410 may be located on an outer side 415 of the arc area formed by the virtual keys 402a-j, as long as one or more noninterfering paths from the input starting point 410 to a destined virtual key are not interfered by other virtual keys among the virtual keys 402a-j. For example, as shown in FIG. 4, a path \textcircled{1} 420 is a noninterfering path from the input starting point 410 to a virtual key “1” 402a; a path \textcircled{2} 430 is a noninterfering path from the input starting point 410 to a virtual key “9” 402i; a path \textcircled{3} 440 is a noninterfering path from the input starting point 410 to a virtual key “4” 402c; a path \textcircled{4} 450 is a noninterfering path from the input starting point 410 to a virtual key “8” 402h. When the user wants to input 1, the user may control the focus of attention to move from the input starting point 410 to the virtual key “1” 402a along the path \textcircled{1} 420.

FIG. 5 is a diagram illustrating another example virtual keyboard layout 500 for informational input in a VR environment, according to an implementation of the present disclosure. The virtual keyboard layout 500 shows a first example location relationship between an input starting point 510 and virtual keys “1” 502a, “2” 502b, “3” 502c, “4” 502d, “5” 502e, “6” 502f, “7” 502g, “8” 502h, “9” 502i, and “0” 502j. The virtual keys 502a-j are arranged along a ring or a circle. The input starting point 510 is located inside the circle formed by the virtual keys 502a-j, to ensure that one or more noninterfering paths from the input starting point 510 to a destined virtual key are not interfered by other virtual keys among the virtual keys 502a-j. For example, as shown in FIG. 5, a path \textcircled{1} 520 is a noninterfering path from the input starting point 510 to a virtual key “1” 502a; a path \textcircled{2} 530 is a noninterfering path from the input starting point 510 to a virtual key “9” 502i; a path \textcircled{3} 540 is a noninterfering path from the input starting point 510 to a virtual key “3” 502c; a path \textcircled{4} 550 is a noninterfering path from the input starting point 510 to a virtual key “8” 502h. When the user wants to input 1, the user may control the focus of attention to move from the input starting point 510 to the virtual key “1” 502a along the path \textcircled{1} 520.

Referring back to FIG. 2, from 202, method 200 proceeds to 204. At 204, displacement data of a focus of attention is received from sensing hardware. From 204, method 200 proceeds to 206. At 206, in response to determining that the focus of attention reaches the input starting point based on the displacement data, detection of a virtual key input is activated. From 206, method 200 proceeds to 208. At 208, in response to detecting that the focus of attention moves from the input starting point to a first virtual key of the multiple virtual keys, it is determined that the first virtual key is input and the detection of the virtual key input is terminated. After 208, method 200 stops.

In some implementations, during a user's interaction in the VR scenario, certain operation error may occur. The disclosed techniques can tolerate or correct certain operation errors of the user. As an example, the disclosed techniques can tolerate or correct an otherwise erroneous determination that the input of the target virtual key is already completed, whereas the focus of attention of a user has not been moved to a region where a target virtual key is located (for example, due to a pause).

In some implementations, in response to detecting that the focus of attention, starting from the input starting point, stops or changes a direction, before reaching to any of the multiple virtual keys, a path of the focus of attention during the detection of the virtual key input can be collected, for example, by the VR client terminal. In some implementations, if the path of the focus of attention meets one or more predetermined conditions, it can be determined that a target virtual key is input by the user and the current virtual key input detection is terminated.

In some implementations, for each virtual key, a reference point may be pre-selected from a region where the virtual key is located. The reference point can be marked as a point A for ease of description. The point A may be a center or another point in the region where the virtual key is located. In addition, the input starting point may be referred to as a point O. Any point on the path of the focus of attention is referred to as a point P, and a point where the focus of attention dwells when moving in a reverse direction is referred to as a point B.

For example, it can be determined that a target virtual key is input and terminating the detection of the virtual key input, in response to determining that the path of the focus of attention meets the following conditions: a distance from any point P on the path of the focus of attention to a straight line on which a line segment OA resides is within a first predetermined threshold range; and a length of a projection of \vec{OP} on \vec{OA} is within a predetermined second threshold range; and a length of a projection of \vec{OB} on \vec{OA} is within a third predetermined threshold range, wherein O is the input starting point, A is a pre-selected point from a region where the target virtual key is located, and B is a point where the focus of attention stops or changes the direction.

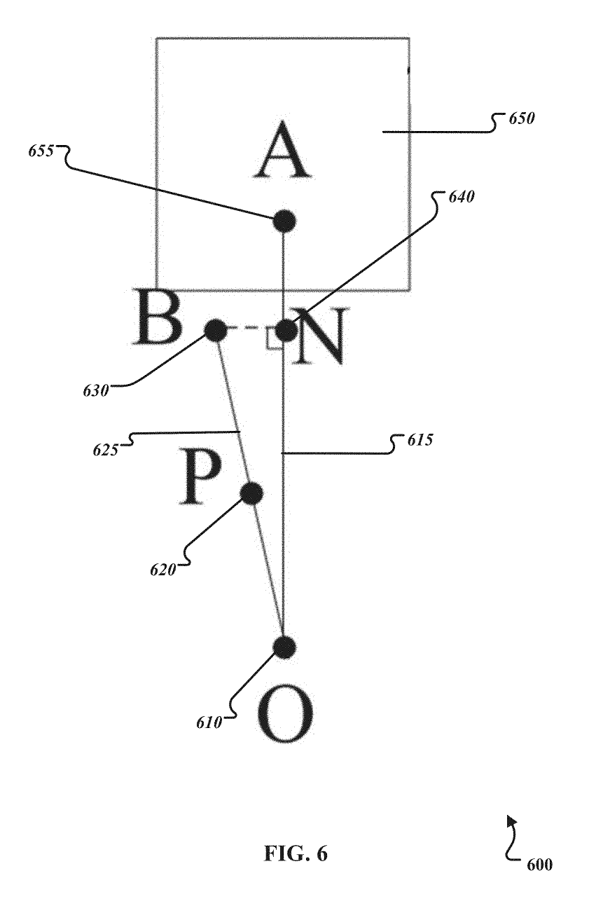

FIG. 6 is a block diagram illustrating an example path 600 of a focus of attention, according to an implementation of the present disclosure. Point O 610 is the input starting point. A square region indicates a virtual key 650. Point A 655 is a reference point pre-selected from the virtual key 650. The line segment OB 625 represents an actual path of the focus of attention. Point B 630 is a point where the focus of attention stops after departing from the input starting point O 610. Point P 620 is any point on the path 625 of the focus of attention.

As an example, the predetermined conditions can include:

(1) A distance from the point P 620 to a straight line 615 where a predetermined line segment OA is located is within a first predetermined threshold range (or interval). The first threshold interval can be set by a developer, to ensure that the point P 620 is not too far away from the straight line 615 where the line segment OA is located.

In some implementations, in calculating the distance from the point P 620 to the straight line 615 where the predetermined line segment OA is located, a perpendicular line (not shown) to the straight line 615 where the line segment OA is located can be made through the point P 620. Supposing the perpendicular line intersects with the straight line 615 where the line segment OA is located at point M (not shown), the length of line segment PM equals to the distance from the point P to the straight line 615 where the predetermined line segment OA is located.

(2) The length of a projection of \vec{OP} on \vec{OA} is within a second predetermined threshold interval.

In some implementations, the length of the projection equals to the length of a line segment OM. The second threshold interval can also be set by the developer, for example, to be [0, (1+d)×|OA|], where |OA| indicates the length of the line segment OA, and a value of d can be 0.1 or another value.

(3) The length of a projection of \vec{OB} on \vec{OA} is within a third predetermined threshold interval.

In some implementations, referring to FIG. 6, the length of the projection of \vec{OB} on \vec{OA} equals to the length of a line segment ON. The third threshold interval can also be set by the developer, for example, [k×|OA|, (1+d)×|OA|], where a value of k can be 0.8 and a value of d can be 0.1, or another value.

In some implementations, when the path of the focus of attention meets the foregoing three conditions, it can be determined that the virtual key 650 is input by the user and the current virtual key input detection is terminated. In some implementations, it may be determined, through calculation, whether a path of the focus of attention and a reference point on each virtual key meet the foregoing conditions, and a virtual key meeting the conditions can be regarded as a target virtual key input by the user. In some implementations, such a determination can be important for a circularly arranged virtual keyboard, and can effectively avoid or reduce the likelihood of misdetection.

In some implementations, the foregoing predetermined conditions can also be used to detect whether the focus of attention of the user moves from the input starting point to a virtual key. That is, after the virtual key input detection is activated, the path of the focus of attention can be collected, and it can be further determined in real time whether the path and each virtual key meet the foregoing predetermined conditions. When the path and a virtual key meet the foregoing predetermined conditions, it can be determined that this virtual key is input by the user.

In some implementations, the described informational input techniques can be implemented in a computing apparatus in a VR scenario. The computing apparatus can be applied to a terminal device on which a VR client terminal is installed. The computing apparatus can be implemented by software or hardware; or can also be implemented in a software-hardware-combined manner. Using software implementation as an example, as a logical apparatus, the apparatus can be formed after a processor of the terminal device reads corresponding computer program instructions from a non-volatile storage device to a memory and runs the instructions.

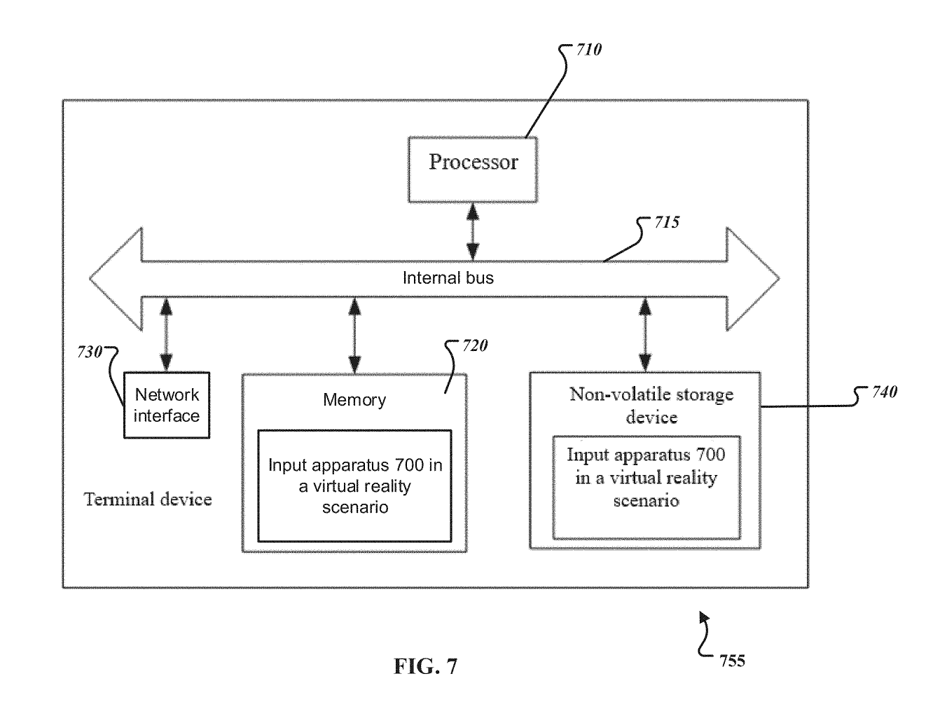

FIG. 7 is a block diagram illustrating an example architecture of a hardware computing apparatus 755 in a VR scenario, according to an implementation of the present disclosure. In some implementations, the hardware computing apparatus 755 can be a terminal device where an input apparatus 700 in a VR scenario is located, according to an implementation of the present disclosure. The hardware computing apparatus 755 can include a processor 710, an internal bus 715, a memory 720, a network interface 730, and a non-volatile storage device 740. In some implementations, the hardware computing apparatus 755 can also include other hardware according to functions of the terminal device, and details are not described herein.

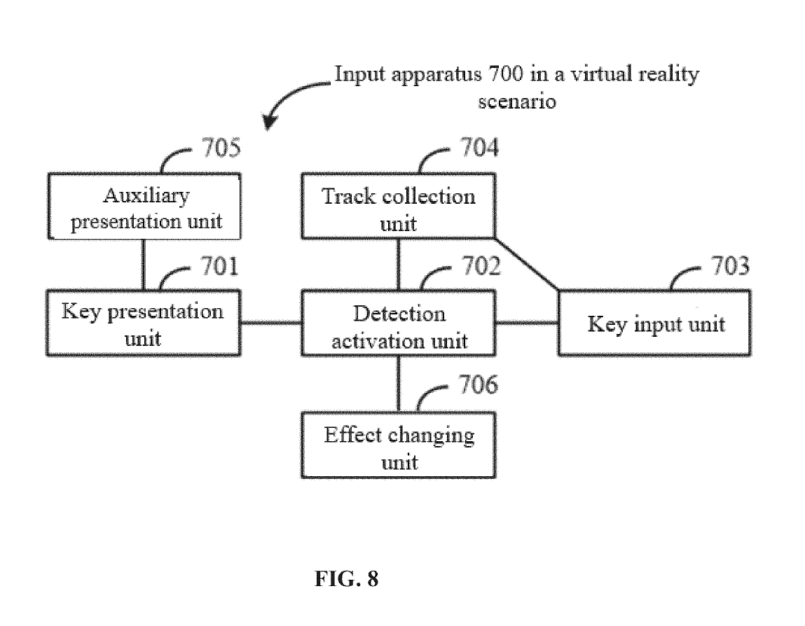

FIG. 8 is a block diagram illustrating an example hardware input apparatus 700 in a VR scenario, according to an implementation of the present disclosure. The input apparatus 700 can be applied to a VR client terminal installed on the terminal device 755 as shown in FIG. 7. The input apparatus 700 can include a key presentation unit 701, a detection activation unit 702, a key input unit 703, a track collection unit 704, an auxiliary presentation unit 705, and an effect changing unit 706.

The key presentation unit 701 is configured to present an input starting point and multiple virtual keys in the VR scenario, in response to receiving an indication of an input initiation. Each of the multiple virtual keys has at least one noninterfering path from the input starting point to the each of the multiple virtual keys, wherein the noninterfering path from the input starting point to the each of the multiple virtual keys is not interfered by any other one of the multiple virtual keys.

The track collection unit 704 is configured to receive displacement data of a focus of attention from sensing hardware.

The detection activation unit 702 is configured to activate a virtual key input detection, in response to determining that the focus of attention reaches the input starting point based on the displacement data.

The key input unit 703 is configured to determine, in response to detecting that the focus of attention moves from the input starting point to a first virtual key of the multiple virtual keys, that the first virtual key is input; and terminating the detection of the virtual key input.

The track collection unit 704 is further configured to collect a path of the focus of attention during the detection of the virtual key input, in response to detecting that the focus of attention, starting from the input starting point, stops or changes a direction, before reaching to any of the multiple virtual keys.

The key input unit 703 is further configured to determine that a target virtual key is input and terminating the detection of the virtual key input, in response to determining that the path of the focus of attention meets the following conditions: wherein O is the input starting point, A is a pre-selected point from a region where the target virtual key is located, and B is a point where the focus of attention stops or changes the direction; and a distance from any point P on the path of the focus of attention to a straight line on which a line segment OA resides is within a first predetermined threshold range; and a length of a projection of \vec{OP} on \vec{OA} is within a second predetermined threshold range; and a length of a projection of \vec{OB} on \vec{OA} is within a third predetermined threshold range.

In some implementations, the multiple virtual keys are aligned along a straight line, and the input starting point is located on either side of an elongated area formed by the multiple virtual keys.

In some implementations, the multiple virtual keys are arranged along an arc, the input starting point is located on an inner side of the arc.

In some implementations, the multiple virtual keys are arranged along a circle, the input starting point is located inside the circle.

The auxiliary presentation unit 705 is configured to present an animation or an auxiliary line in the VR scenario to prompt the user to input a virtual key, in response to receiving an indication of an input initiation.

The effect changing unit 706 is configured to change a presentation effect of the focus of attention when the virtual key input detection is activated.

In some implementations, a gap exists between each two closest virtual keys of the multiple virtual keys.

Those of ordinary skill in the art will be able to conceive of other implementations of the present disclosure following consideration of the instant specification and practice of the disclosed subject matter. The present disclosure is intended to cover any variations, usages, or adaptations of the described subject matter, including variations, usages, or adaptations consistent with the general principles of the present disclosure, and including common knowledge or non-disclosed conventional technical means in the art. The provided examples are intended to enhance understanding of the described concepts, and are not intended to limit applicability of the disclosure in any way.

It should also be understood that, the present disclosure is not limited only the described implementations or as illustrated in the accompanying drawings. Various modifications and changes may be made without departing from the scope of the present application. The scope of the present application is limited only by the included claims. Any modifications, equivalent replacements, or improvements made within the spirit and principles of the present disclosure are considered to be within the scope and protection scope of the present disclosure.

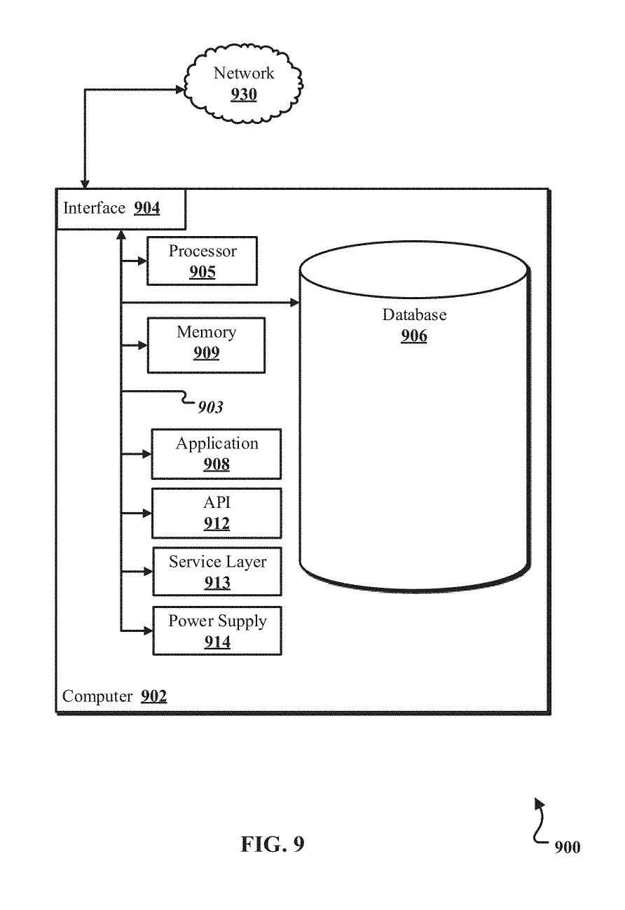

FIG. 9 is a block diagram illustrating an example of a computer-implemented system 900 used to provide computational functionalities associated with described algorithms, methods, functions, processes, flows, and procedures, according to an implementation of the present disclosure. In the illustrated implementation, system 900 includes a computer 902 and a network 930.

The illustrated computer 902 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 902 can comprise a computer that includes an input device, such as a keypad, keyboard, touch screen, another input device, or a combination of input devices that can accept user information, and an output device that conveys information associated with the operation of the computer 902, including digital data, visual, audio, another type of information, or a combination of types of information, on a GUI or other user interface UI.

The computer 902 can serve in a role in a distributed computing system as a client, network component, a server, a database or another persistency, another role, or a combination of roles for performing the subject matter described in the present disclosure. The illustrated computer 902 is communicably coupled with a network 930. In some implementations, one or more components of the computer 902 can be configured to operate within an environment, including cloud-computing-based, local, global, another environment, or a combination of environments.

At a high level, the computer 902 is an electronic computing device operable to receive, transmit, process, store, or manage data and information associated with the described subject matter. According to some implementations, the computer 902 can also include or be communicably coupled with a server, including an application server, e-mail server, web server, caching server, streaming data server, another server, or a combination of servers.

The computer 902 can receive requests over network 930 (for example, from a client software application executing on another computer 902) and respond to the received requests by processing the received requests using a software application or a combination of software applications. In addition, requests can also be sent to the computer 902 from internal users (for example, from a command console or by another internal access method), external or third-parties, or other entities, individuals, systems, or computers.

Each of the components of the computer 902 can communicate using a system bus 903. In some implementations, any or all of the components of the computer 902, including hardware, software, or a combination of hardware and software, can interface over the system bus 903 using an application programming interface (API) 912, a service layer 913, or a combination of the API 912 and service layer 913. The API 912 can include specifications for routines, data structures, and object classes. The API 912 can be either computer-language independent or dependent and refer to a complete interface, a single function, or even a set of APIs. The service layer 913 provides software services to the computer 902 or other components (whether illustrated or not) that are communicably coupled to the computer 902. The functionality of the computer 902 can be accessible for all service consumers using this service layer. Software services, such as those provided by the service layer 913, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 902, alternative implementations can illustrate the API 912 or the service layer 913 as stand-alone components in relation to other components of the computer 902 or other components (whether illustrated or not) that are communicably coupled to the computer 902. Moreover, any or all parts of the API 912 or the service layer 913 can be implemented as a child or a sub-module of another software module, enterprise application, or hardware module without departing from the scope of the present disclosure.

The computer 902 includes an interface 904. Although illustrated as a single interface 904 in FIG. 9, two or more interfaces 904 can be used according to particular needs, desires, or particular implementations of the computer 902. The interface 904 is used by the computer 902 for communicating with another computing system (whether illustrated or not) that is communicatively linked to the network 930 in a distributed environment. Generally, the interface 904 is operable to communicate with the network 930 and comprises logic encoded in software, hardware, or a combination of software and hardware. More specifically, the interface 904 can comprise software supporting one or more communication protocols associated with communications such that the network 930 or interface's hardware is operable to communicate physical signals within and outside of the illustrated computer 902.

The computer 902 includes a processor 905. Although illustrated as a single processor 905 in FIG. 9, two or more processors can be used according to particular needs, desires, or particular implementations of the computer 902. Generally, the processor 905 executes instructions and manipulates data to perform the operations of the computer 902 and any algorithms, methods, functions, processes, flows, and procedures as described in the present disclosure.

The computer 902 also includes a database 906 that can hold data for the computer 902, another component communicatively linked to the network 930 (whether illustrated or not), or a combination of the computer 902 and another component. For example, database 906 can be an in-memory, conventional, or another type of database storing data consistent with the present disclosure. In some implementations, database 906 can be a combination of two or more different database types (for example, a hybrid in-memory and conventional database) according to particular needs, desires, or particular implementations of the computer 902 and the described functionality. Although illustrated as a single database 906 in FIG. 9, two or more databases of similar or differing types can be used according to particular needs, desires, or particular implementations of the computer 902 and the described functionality. While database 906 is illustrated as an integral component of the computer 902, in alternative implementations, database 906 can be external to the computer 902.

The computer 902 also includes a memory 909 that can hold data for the computer 902, another component or components communicatively linked to the network 930 (whether illustrated or not), or a combination of the computer 902 and another component. Memory 909 can store any data consistent with the present disclosure. In some implementations, memory 909 can be a combination of two or more different types of memory (for example, a combination of semiconductor and magnetic storage) according to particular needs, desires, or particular implementations of the computer 902 and the described functionality. Although illustrated as a single memory 909 in FIG. 9, two or more memories 909 or similar or differing types can be used according to particular needs, desires, or particular implementations of the computer 902 and the described functionality. While memory 909 is illustrated as an integral component of the computer 902, in alternative implementations, memory 909 can be external to the computer 902.

The application 908 is an algorithmic software engine providing functionality according to particular needs, desires, or particular implementations of the computer 902, particularly with respect to functionality described in the present disclosure. For example, application 908 can serve as one or more components, modules, or applications. Further, although illustrated as a single application 908, the application 908 can be implemented as multiple applications 908 on the computer 902. In addition, although illustrated as integral to the computer 902, in alternative implementations, the application 908 can be external to the computer 902.

The computer 902 can also include a power supply 914. The power supply 914 can include a rechargeable or non-rechargeable battery that can be configured to be either user- or non-user-replaceable. In some implementations, the power supply 914 can include power-conversion or management circuits (including recharging, standby, or another power management functionality). In some implementations, the power-supply 914 can include a power plug to allow the computer 902 to be plugged into a wall socket or another power source to, for example, power the computer 902 or recharge a rechargeable battery.

There can be any number of computers 902 associated with, or external to, a computer system containing computer 902, each computer 902 communicating over network 930. Further, the term “client,” “user,” or other appropriate terminology can be used interchangeably, as appropriate, without departing from the scope of the present disclosure. Moreover, the present disclosure contemplates that many users can use one computer 902, or that one user can use multiple computers 902.

Described implementations of the subject matter can include one or more features, alone or in combination.

For example, in a first implementation, a computer-implemented method, comprising: in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys; receiving displacement data of a focus of attention from sensing hardware; in response to determining that the focus of attention reaches the input starting point based on the displacement data, activating detection of a virtual key input; and in response to detecting that the focus of attention moves from the input starting point to a first virtual key of the plurality of virtual keys, determining that the first virtual key is input; and terminating the detection of the virtual key input.

In a second implementation, a non-transitory, computer-readable medium storing one or more instructions executable by a computer system to perform operations comprising: in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys; receiving displacement data of a focus of attention from sensing hardware; in response to determining that the focus of attention reaches the input starting point based on the displacement data, activating detection of a virtual key input; and in response to detecting that the focus of attention moves from the input starting point to a first virtual key of the plurality of virtual keys, determining that the first virtual key is input; and terminating the detection of the virtual key input.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform operations comprising: in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys; receiving displacement data of a focus of attention from sensing hardware; in response to determining that the focus of attention reaches the input starting point based on the displacement data, activating detection of a virtual key input; and in response to detecting that the focus of attention moves from the input starting point to a first virtual key of the plurality of virtual keys, determining that the first virtual key is input; and terminating the detection of the virtual key input.

The foregoing and other described implementations can each, optionally, include one or more of the following features:

A first feature, combinable with any of the following features, wherein the method or the operations further comprise: in response to detecting that the focus of attention, starting from the input starting point, stops or changes a direction, before reaching to any of the plurality of virtual keys, collecting a path of the focus of attention during the detection of the virtual key input; and determining that a target virtual key is input and terminating the detection of the virtual key input, in response to determining that the path of the focus of attention meets the following conditions: wherein O is the input starting point, A is a pre-selected point from a region where the target virtual key is located, and B is a point where the focus of attention stops or changes the direction; and a distance from any point P on the path of the focus of attention to a straight line on which a line segment OA resides is within a first predetermined threshold range; and a length of a projection of \vec{OP} on \vec{OA} is within a second predetermined threshold range; and a length of a projection of \vec{OB} on \vec{OA} is within a third predetermined threshold range.

A second feature, combinable with any of the previous or following features, wherein the plurality of virtual keys are aligned along a straight line, and the input starting point is located on either side of an elongated area formed by the plurality of virtual keys.

A third feature, combinable with any of the previous or following features, wherein the plurality of virtual keys are arranged along an arc, the input starting point is located on an inner side of the arc.

A fourth feature, combinable with any of the previous or following features, wherein the plurality of virtual keys are arranged along a circle, the input starting point is located inside the circle.

A fifth feature, combinable with any of the previous or following features, wherein the method or the operations further comprise, in response to receiving an indication of an input initiation, presenting an animation or an auxiliary line in the VR scenario to prompt the user how to input a virtual key.

A sixth feature, combinable with any of the previous or following features, wherein the method or the operations further comprise, in response to activating of the detection of the virtual key input, changing a presentation effect of the focus of attention when the virtual key input detection is activated.

A seventh feature, combinable with any of the previous or following features, wherein a gap exists between each two closest virtual keys of the plurality of virtual keys.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include multiple user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys;
receiving displacement data of a focus of attention from sensing hardware;
in response to determining that the focus of attention reaches the input starting point based on the displacement data, activating detection of a virtual key input; and
in response to detecting that the focus of attention moves from the input starting point to a first virtual key of the plurality of virtual keys, determining that the first virtual key is input; and
terminating the detection of the virtual key input.

2. The method of claim 1, further comprising:
in response to detecting that the focus of attention, starting from the input starting point, stops or changes a direction, before reaching to any of the plurality of virtual keys, collecting a path of the focus of attention during the detection of the virtual key input; and
determining that a target virtual key is input and terminating the detection of the virtual key input, in response to determining that the path of the focus of attention meets the following conditions:
wherein O is the input starting point, A is a pre-selected point from a region where the target virtual key is located, and B is a point where the focus of attention stops or changes the direction; and
a distance from any point P on the path of the focus of attention to a straight line on which a line segment OA resides is within a first predetermined threshold range; and
a length of a projection of \vec{OP} on \vec{OA} is within a second predetermined threshold range; and
a length of a projection of \vec{OB} on \vec{OA} is within a third predetermined threshold range.

3. The method of claim 1, wherein the plurality of virtual keys are aligned along a straight line, and the input starting point is located on either side of an elongated area formed by the plurality of virtual keys.

4. The method of claim 1, wherein the plurality of virtual keys are arranged along an arc, the input starting point is located on an inner side of the arc.

5. The method of claim 1, wherein the plurality of virtual keys are arranged along a circle, the input starting point is located inside the circle.

6. The method of claim 1, further comprising, in response to receiving an indication of an input initiation, presenting an animation or an auxiliary line in the VR scenario to prompt the user how to input a virtual key.

7. The method of claim 1, further comprising, in response to activating of the detection of the virtual key input, changing a presentation effect of the focus of attention when the virtual key input detection is activated.

8. The method of claim 1, wherein a gap exists between each two closest virtual keys of the plurality of virtual keys.

9. A non-transitory, computer-readable medium storing one or more instructions executable by a computer system to perform operations comprising:
in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys;
receiving displacement data of a focus of attention from sensing hardware;
in response to determining that the focus of attention reaches the input starting point based on the displacement data, activating detection of a virtual key input; and
in response to detecting that the focus of attention moves from the input starting point to a first virtual key of the plurality of virtual keys, determining that the first virtual key is input; and terminating the detection of the virtual key input.

10. The computer-readable medium of claim 9, wherein the operations further comprise:
in response to detecting that the focus of attention, starting from the input starting point, stops or changes a direction, before reaching to any of the plurality of virtual keys, collecting a path of the focus of attention during the detection of the virtual key input; and
determining that a target virtual key is input and terminating the detection of the virtual key input, in response to determining that the path of the focus of attention meets the following conditions:
wherein O is the input starting point, A is a pre-selected point from a region where the target virtual key is located, and B is a point where the focus of attention stops or changes the direction; and
a distance from any point P on the path of the focus of attention to a straight line on which a line segment OA resides is within a first predetermined threshold range; and
a length of a projection of \vec{OP} on \vec{OA} is within a second predetermined threshold range; and
a length of a projection of \vec{OB} on \vec{OA} is within a third predetermined threshold range.

11. The computer-readable medium of claim 9, wherein the plurality of virtual keys are aligned along a straight line, and the input starting point is located on either side of an elongated area formed by the plurality of virtual keys.

12. The computer-readable medium of claim 9, wherein the plurality of virtual keys are arranged along an arc, the input starting point is located on an inner side of the arc.

13. The computer-readable medium of claim 9, wherein the plurality of virtual keys are arranged along a circle, the input starting point is located inside the circle.

14. The computer-readable medium of claim 9, wherein the operations further comprise, in response to receiving an indication of an input initiation, presenting an animation or an auxiliary line in the VR scenario to prompt the user how to input a virtual key.

15. The computer-readable medium of claim 9, wherein the operations further comprise, in response to activating of the detection of the virtual key input, changing a presentation effect of the focus of attention when the virtual key input detection is activated.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
in response to receiving an indication of an input initiation, presenting an input starting point and a plurality of virtual keys in a virtual reality scenario, wherein each of the plurality of virtual keys has at least one noninterfering path from the input starting point to the each of the plurality of virtual keys, wherein the noninterfering path from the input starting point to the each of the plurality of virtual keys is not interfered by any other one of the plurality of virtual keys;
receiving displacement data of a focus of attention from sensing hardware;
in response to determining that the focus of attention reaches the input starting point based on the displacement data, activating detection of a virtual key input; and
in response to detecting that the focus of attention moves from the input starting point to a first virtual key of the plurality of virtual keys, determining that the first virtual key is input; and terminating the detection of the virtual key input.

17. The computer-implemented system of claim 16, wherein the operations further comprise:
in response to detecting that the focus of attention, starting from the input starting point, stops or changes a direction, before reaching to any of the plurality of virtual keys, collecting a path of the focus of attention during the detection of the virtual key input; and
determining that a target virtual key is input and terminating the detection of the virtual key input, in response to determining that the path of the focus of attention meets the following conditions:
wherein O is the input starting point, A is a pre-selected point from a region where the target virtual key is located, and B is a point where the focus of attention stops or changes the direction; and
a distance from any point P on the path of the focus of attention to a straight line on which a line segment OA resides is within a first predetermined threshold range; and
a length of a projection of \vec{OP} on \vec{OA} is within a second predetermined threshold range; and
a length of a projection of \vec{OB} on \vec{OA} is within a third predetermined threshold range.

18. The computer-implemented system of claim 16, wherein the plurality of virtual keys are aligned along a straight line, and the input starting point is located on either side of an elongated area formed by the plurality of virtual keys.

19. The computer-implemented system of claim 16, wherein the plurality of virtual keys are arranged along an arc, the input starting point is located on an inner side of the arc.

20. The computer-implemented system of claim 16, wherein the plurality of virtual keys are arranged along a circle, the input starting point is located inside the circle.
